(19) United States
(12) Patent Application Publication
(10) Pub. No.: US 2007/0052700 A1
(43) Pub. Date: Mar. 8, 2007

(54) System and method for 3D CAD using projection images

(76) Inventors: Frederick Wilson Wheeler, Niskayuna, NY (US); John Patrick Kaufhold, Arlington, VA (US); Bernhard Erich Hermann Claus, Niskayuna, NY (US); Ambalangoda Gurunnanselage Amitha Perera, Clifton Park, NY (US); Serge Louis Wilfrid Muller, Guyancourt (FR); Razvan Gabriel Iordache, Paris (FR)

Correspondence Address: Patrick S. Yoder;FLETCHER YODER, P.O. Box 692289, Houston, TX, 77269-2289, US

(21) Appl. No.: 11/220,496

(22) Filed: Sep. 7, 2005

(51) Int. Cl. G06T 15/00

(52) U.S. Cl. 345/419

(57) ABSTRACT

A technique is provided for performing a computer aided detection (CAD) analysis of a three-dimensional volume using a computer assisted detection and/or diagnosis (CAD) algorithms. The technique includes selecting one or more three-dimensional points of interest in a three-dimensional volume, forward projecting the one or more three-dimensional points of interest to determine a corresponding set of projection points within one or more two-dimensional projection images, and computing output values at the one or more three-dimensional points of interest based on one or more feature values or a CAD output at the corresponding set of projection points.

### BACKGROUND

The invention relates generally to medical imaging procedures. In particular, the present invention relates to techniques for improving detection and diagnosis of medical conditions by utilizing computer aided detection and/or diagnosis (CAD) techniques.

Computer aided diagnosis or detection (CAD) techniques facilitate automated screening and evaluation of disease states, medical or physiological events and conditions. Such techniques are typically based upon various types of analysis of one or a series of collected images of the anatomy of interest. The collected images are typically analyzed by various processing steps, such as routines for segmentation, feature extraction, and/or classification, to detect anatomic signatures of pathologies. The results are then generally viewed by radiologists for final diagnoses. Such techniques may be used in a range of applications, such as mammography, lung cancer screening or colon cancer screening.

A CAD algorithm offers the potential for automatically identifying certain anatomic signatures of interest, such as cancer, or other anomalies. CAD algorithms are generally selected based upon the family or type of signature or anomaly to be identified, and are usually specifically adapted for the imaging modality used to create the image data. CAD algorithms may be utilized in a variety of imaging modalities, such as, for example, tomosynthesis systems, computed tomography (CT) systems, X-ray C-arm systems, magnetic resonance imaging (MRI) systems, X-ray systems, ultrasound systems (US), positron emission tomography (PET) systems, and so forth. Each imaging modality is based upon unique physics and image formation and reconstruction techniques, and each imaging modality may provide unique advantages over other modalities for imaging a particular anatomical or physiological signature of interest or detecting a certain type of disease or physiological condition. CAD algorithms used in each of these modalities may therefore provide advantages over those used in other modalities, depending upon the imaging capabilities of the modality, the tissue being imaged, and so forth.

For example, in 3D tomosynthesis a series of 2D X-ray images are taken, each with a different imaging geometry relative to the imaged volume. A 3D image is generally reconstructed from the 2D projection images via tomosynthesis. A radiologist reading a 3D tomographic image will benefit from assistance from a CAD system that automatically detects and/or diagnoses anomalies or malignancies and also from other processing and enhancement techniques, such as Digital Contrast Agents (DCA) or Findings-Based Filtration that are designed to make subtle visual signs of cancer (and pre-cancerous and other structures) more apparent. Such processing and enhancement techniques are generally included in the concept of CAD processing.

Typically, CAD processing in a tomography system may be performed on a two-dimensional reconstructed image, on a three-dimensional reconstructed volume, or a suitable combination of such formats. Generally, in CAD processing of tomosynthesis image data, a 2D or 3D reconstructed image or volume is input to a CAD algorithm, which typically segments points or regions, computes features for each sample point or segmented region in the reconstructed image as well as classifies and/or detects the features where appropriate.

Further, as is known to those skilled in the art, reconstruction can be performed using different reconstruction algorithms and different reconstruction parameters to generate images with different characteristics. Depending on the particular reconstruction algorithm used, different anatomical signatures or anomalies may be detected with varying degrees of confidence and accuracy by the CAD algorithm. The CAD algorithm may therefore be adapted to be able to evaluate features that come from several different reconstructions to improve the detection of one or more anatomical signatures of interest.

However, in building a CAD system for 3D tomosynthesis there are certain disadvantages to using a full 3D reconstruction. For example, a 3D tomosynthesis breast image reconstruction may be large and may require extensive computer memory and CPU time for storage and processing respectively. Further, the spatial distortion and random noise characteristics of a 3D tomosynthesis breast image reconstruction may be complicated, requiring complicated algorithms and more CPU time to appropriately model and account for them in a detection or diagnosis algorithm. In addition, in order to optimally leverage the information that is present in the acquired dataset, several different reconstructions may have to be performed, in order to optimize the detection accuracy and the confidence level of a CAD system.

It is therefore desirable to provide an efficient and improved method for performing 3D CAD processing for 3D tomosynthesis using the projection images directly without relying solely on a 3D reconstruction so as to improve detection accuracy and confidence and potentially reduce the processing and storage requirements.

### BRIEF DESCRIPTION

Briefly in accordance with one aspect of the technique, a method is provided for performing a computer aided detection (CAD) analysis of a three-dimensional volume. The method provides for selecting one or more three-dimensional points of interest in a three-dimensional volume, forward projecting the one or more three-dimensional points of interest to determine a corresponding set of projection points within one or more two-dimensional projection images, and computing output values at the one or more three-dimensional points of interest based on one or more feature values or a CAD output at the corresponding set of projection points. Processor-based systems and computer programs that afford functionality of the type defined by this method may be provided by the present technique.

In accordance with another aspect of the technique, a method is provided for performing a computer aided detection (CAD) analysis of a three-dimensional volume. The method provides for acquiring a plurality of projection images of the three-dimensional volume, selecting one or more classification points within the three-dimensional volume, determining a projection point for each classification point within each of one or more projection images based on a respective imaging geometry of each of the one or more projection images, and computing one or more feature values within each of the one or more projection images. Each feature value is calculated using a region of the respective projection image proximate to a respective projection point within the respective projection image. The method also provides for classifying each classification point using the respective feature values for the respective projection points associated with each classification point. Processor-based systems and computer programs that afford functionality of the type defined by this method may be provided by the present technique.

### DRAWINGS

These and other features, aspects, and advantages of the present invention will become better understood when the following detailed description is read with reference to the accompanying drawings in which like characters represent like parts throughout the drawings, wherein:

FIG. 1 is a diagrammatical representation of an exemplary imaging system, in this case a tomosynthesis system for producing processed images in accordance with the present technique;

FIG. 2 is a diagrammatical representation of a physical implementation of the system of FIG. 1;

FIG. 3 is an illustration of a CAD system that is configured to operate on 2D projections in accordance with one aspect of the present technique; and

FIG. 4 is an illustration of a CAD system that is configured to operate on 2D projections obtained from reprojection of 3D volumes in accordance with another aspect of the present technique.

### DETAILED DESCRIPTION

The present techniques are generally directed to computer aided detection and/or diagnosis (CAD) techniques for improving detection and diagnosis of medical conditions. Though the present discussion provides examples in a medical imaging context, one of ordinary skill in the art will readily apprehend that the application of these techniques in other contexts, such as for industrial imaging, security screening, and/or baggage or package inspection, is well within the scope of the present techniques.

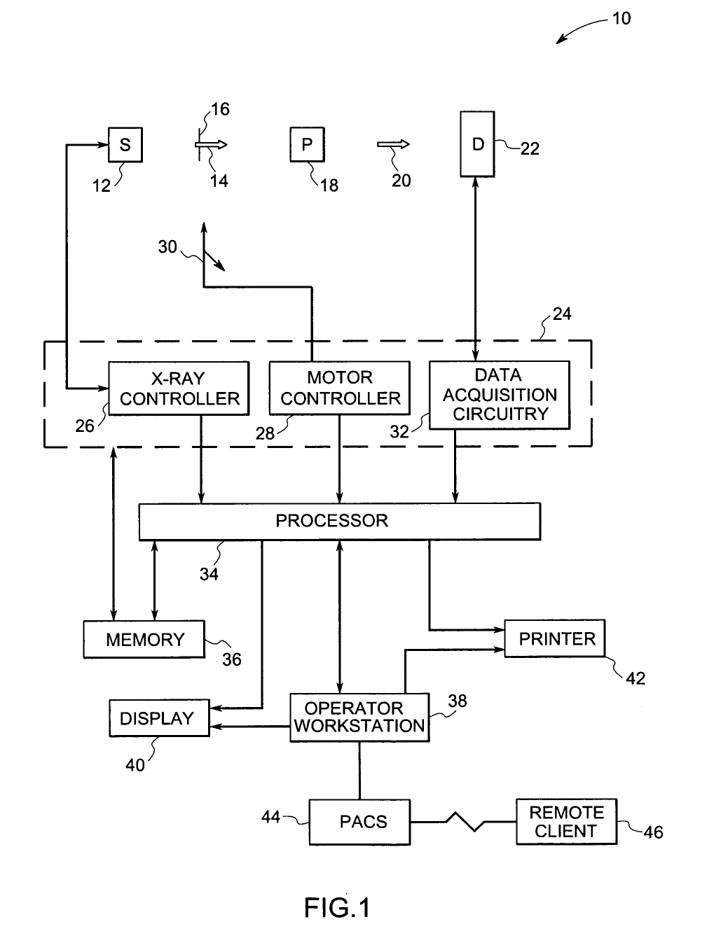

FIG. 1 is a diagrammatical representation of an exemplary imaging system, for acquiring, processing and displaying images in accordance with the present technique. In accordance with a particular embodiment of the present technique, the imaging system is a tomosynthesis system, designated generally by the reference numeral 10, in FIG. 1. However, it should be noted that any multiple projection imaging system may be used for acquiring, processing and displaying images in accordance with the present technique. As used herein, “a multiple projection imaging system” refers to an imaging system wherein multiple projection images may be collected at different angles relative to the imaged anatomy, such as, for example, tomosynthesis systems, PET systems, CT systems and C-Arm systems.

In the illustrated embodiment, tomosynthesis system 10 includes a source 12 of X-ray radiation 14, which is movable generally in a plane, or in three dimensions. In the exemplary embodiment, the X-ray source 12 typically includes an X-ray tube and associated support and filtering components. A collimator 16 may be positioned adjacent to the X-ray source 12. The collimator 16 typically defines the size and shape of the X-ray radiation 14 emitted by X-ray source 12 that pass into a region in which a subject, such as a human patient 18, is positioned. A portion of the radiation 20 passes through and around the subject, and impacts a detector array, represented generally by reference numeral 22.

The detector 22 is generally formed by a plurality of detector elements, which detect the X-rays 20 that pass through or around the subject. For example, the detector 22 may include multiple rows and/or columns of detector elements arranged as an array. Each detector element, when impacted by X-ray flux, produces an electrical signal that represents the integrated energy of the X-ray beam at the position of the element between subsequent signal readout of the detector 22. Typically, signals are acquired at one or more view angle positions around the subject of interest so that a plurality of radiographic views may be collected. These signals are acquired and processed to reconstruct an image of the features within the subject, as described below.

The source 12 is controlled by a system controller 24 which furnishes both power and control signals for tomosynthesis examination sequences, including position of the source 12 relative to the subject 18 and detector 22. Moreover, the detector 22 is coupled to the system controller 24, which commands acquisition of the signals generated by the detector 22. The system controller 24 may also execute various signal processing and filtration functions, such as for initial adjustment of dynamic ranges, interleaving of digital image data, and so forth. In general, the system controller 24 commands operation of the tomosynthesis system 10 to execute examination protocols and to process acquired data. In the present context, the system controller 24 may also include signal processing circuitry, typically based upon a general purpose or application-specific digital computer, and associated memory circuitry. The associated memory circuitry may store programs and routines executed by the computer, configuration parameters, image data, and so forth. For example, the associated memory circuitry may store programs or routines for implementing the present technique.

In the embodiment illustrated in FIG. 1, the system controller 24 includes an X-ray controller 26, which regulates generation of X-rays by the source 12. In particular, the X-ray controller 26 is configured to provide power and timing signals to the X-ray source 12. A motor controller 28 serves to control movement of a positional subsystem 30 that regulates the position and orientation of the source with respect to the subject 18 and detector 22. The positional subsystem 30 may also cause movement of the detector, or even the patient, rather than or in addition to the source 12. It should be noted that in certain configurations, the positional subsystem 30 may be eliminated, particularly where multiple addressable sources are provided. In such configurations, projections may be attained through the triggering of different sources of X-ray radiation positioned accordingly. Further, the system controller 24 may comprise data acquisition circuitry 32. In this exemplary embodiment, the detector 22 is coupled to the system controller 24, and more particularly to the data acquisition circuitry 32. The data acquisition circuitry 32 receives data collected by read-out electronics of the detector 22. The data acquisition circuitry 32 typically receives sampled analog signals from the detector 22 and converts the data to digital signals for subsequent processing by a processor 34. Such conversion, and indeed any preprocessing, may actually be performed to some degree within the detector assembly itself.

The processor 34 is typically coupled to the system controller 24. Data collected by the data acquisition circuitry 32 may be transmitted to the processor 34 for subsequent processing and reconstruction. The processor 34 may comprise or communicate with a memory 36 that can store data processed by the processor 34, or data to be processed by the processor 34. It should be understood that any type of computer accessible memory device suitable for storing and/or processing such data and/or data processing routines may be utilized by such an exemplary tomosynthesis system 10. Moreover, the memory 36 may comprise one or more memory devices, such as magnetic or optical devices, of similar or different types, which may be local and/or remote to the system 10. The memory 36 may store data, processing parameters, and/or computer programs comprising one or more routines for performing the processes described herein. Furthermore, memory 36 may be coupled directly to system controller 24 to facilitate the storage of acquired data.

The processor 34 is typically used to control the tomosynthesis system 10. The processor 34 may also be adapted to control features enabled by the system controller 24, i.e., scanning operations and data acquisition. Furthermore, the processor 34 is configured to receive commands and scanning parameters from an operator via an operator workstation 38, typically equipped with a keyboard, mouse, and/or other input devices. Thus, the operator may observe the reconstructed image and other data relevant to the system from operator workstation 38, initiate imaging, and so forth. Where desired, other computers or workstations may perform some or all of the functions of the present technique, including post-processing of image data simply accessed from memory device 36 or another memory device at the imaging system location or remote from that location.

A display 40 coupled to the operator workstation 38 may be utilized to observe the reconstructed image. Additionally, the scanned image may be printed by a printer 42 coupled to the operator workstation 38. The display 40 and the printer 42 may also be connected to the processor 34, either directly or via the operator workstation 38. Further, the operator workstation 38 may also be coupled to a picture archiving and communications system (PACS) 44. It should be noted that PACS 44 might be coupled to a remote system 46, such as a radiology department information system (RIS), hospital information system (HIS) or to an internal or external network, so that others at different locations may gain access to the image data.

It should be further noted that the processor 34 and operator workstation 38 may be coupled to other output devices, which may include standard or special-purpose computer monitors, computers and associated processing circuitry. One or more operator workstations 38 may be further linked in the system for outputting system parameters, requesting examinations, viewing images, and so forth. In general, displays, printers, workstations and similar devices supplied within the system may be local to the data acquisition components or, may be remote from these components, such as elsewhere within an institution or hospital, or in an entirely different location, linked to the imaging system via one or more configurable networks, such as the Internet, virtual private networks, and so forth.

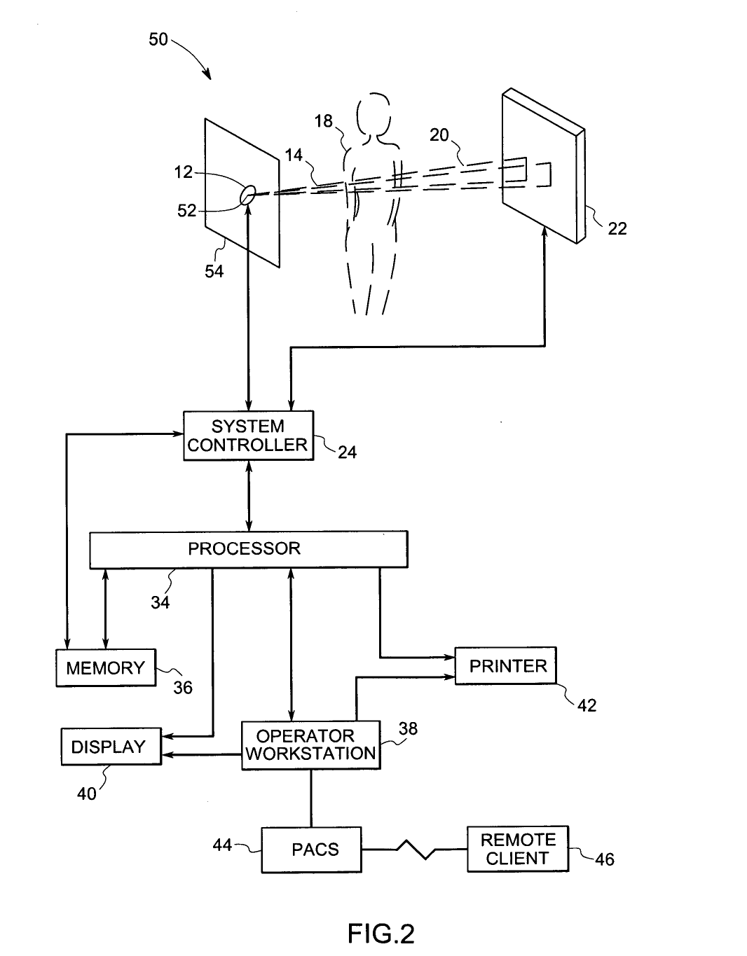

Referring generally to FIG. 2, an exemplary implementation of a tomosynthesis imaging system of the type discussed with respect to FIG. 1 is illustrated. As shown in FIG. 2, an imaging scanner 50 generally permits interposition of a subject 18 between the source 12 and detector 22. Although a space is shown between the subject and detector 22 in FIG. 2, in practice, the subject may be positioned directly before the imaging plane and detector. The detector 22 may, moreover, vary in size and configuration. The X-ray source 12 is illustrated as being positioned at a source location or position 52 for generating one of a series of projections. In general, the source is movable to permit multiple such projections to be attained in an imaging sequence. In the illustration of FIG. 2, a source plane 54 is defined by the array of potential emission positions available for source 12. The source plane 54 may, of course, be replaced by three-dimensional trajectories for a source movable in three-dimensions. Alternatively, two-dimensional or three-dimensional layouts and configurations may be defined for multiple sources, which may or may not be independently movable.

In typical operation, X-ray source 12 emits an X-ray beam from its focal point toward detector 22. A portion of the beam 14 that traverses the subject 18, results in attenuated X-rays 20 which impact detector 22. This radiation is thus attenuated or absorbed by the internal structures of the subject, such as internal anatomies in the case of medical imaging. The detector is formed by a plurality of detector elements generally corresponding to discrete picture elements or pixels in the resulting image data. The individual pixel electronics detect the intensity of the radiation impacting each pixel location and produce output signals representative of the radiation. In an exemplary embodiment, the detector consists of an array of 2048×2048 pixels, with a pixel size of 100×100 μm. Other detector functionalities, configurations, and resolutions are, of course, possible. Each detector element at each pixel location produces an analog signal representative of the impinging radiation that is converted to a digital value for processing.

Source 12 is moved and triggered, or distributed sources are similarly triggered at different locations, to produce a plurality of projections or images from different source locations. These projections are produced at different view angles and the resulting data is collected by the imaging system. In an exemplary embodiment, the source 12 is positioned approximately 180 cm from the detector, in a total range of motion of the source between 31 cm and 131 cm, resulting in a 5° to 20° movement of the source from a center position. In a typical examination, many such projections may be acquired, typically a hundred or fewer, although this number may vary.

Data collected from the detector 22 then typically undergo correction and pre-processing to condition the data to represent the line integrals of the attenuation coefficients of the scanned objects, although other representations are also possible. The processed data, commonly called projection images, are then typically input to a reconstruction algorithm to formulate a volumetric image of the scanned volume. In tomosynthesis, a limited number of projection images are acquired, typically a hundred or fewer, each at a different angle relative to the object and/or detector. Reconstruction algorithms are typically employed to perform the reconstruction on this projection image data to produce the volumetric image.

Once reconstructed, the volumetric image produced by the system of FIGS. 1 and 2 reveals the three-dimensional characteristics and spatial relationships of internal structures of the subject 18. Reconstructed volumetric images may be displayed to show the three-dimensional characteristics of these structures and their spatial relationships. The reconstructed volumetric image is typically arranged in slices. In some embodiments, a single slice may correspond to structures of the imaged object located in a plane that is conventionally parallel to the detector plane, but reconstructing a slice in any orientation is possible. Though the reconstructed volumetric image may comprise a single reconstructed slice representative of structures at the corresponding location within the imaged volume, more than one slice image is typically computed. Alternatively, the reconstructed data may not be arranged in slices.

As will be appreciated by one skilled in the art, the reconstructed volumetric images of the anatomy may further be evaluated via a CAD system that automatically detects and/or diagnoses certain anatomical features and/or pathologies. The goal of CAD is generally to determine the state of tissue at a point or region, or many points or regions. CAD may be a hard classifier and assign each point in the image or region to a distinct class. Classes may be selected to represent the various normal anatomic signatures and also the signatures of anatomic anomalies the CAD system is designed to detect. There may be many classes for many specific benign and malignant conditions. Some examples of classes for mammography are “fibroglandular tissue”, “lymph node”, “spiculated mass”, and “calcification cluster”. However, the names of the classes and their meanings may vary widely in a particular CAD system and may in practice be more abstract than these simple examples. The output may be a classification (hard-decision) or some measure that is related to the presence of a particular anatomical feature and that can be displayed directly to a radiologist. In certain embodiments, CAD may output soft parameters or a combination of hard and soft parameters. The soft parameters may include a list of points or regions where an anomaly may exist, along with a probability or degree of confidence for each location. The soft decision output of the CAD system may also be a map of vectors of probabilities, with a probability given for each of the tissue classes the CAD system understands, which include anomalies and normal tissue. The soft decision output of the CAD system may also be a map of the detection strength for a particular anatomic feature or abnormality, or a vector of such detection strengths. For example, in mammography, the CAD system may output a value at each sample point that indicates the strength of the apparent calcification signal at the sample point, or indicates the strength of the apparent spiculation at or about the sample point. Such a map of detection strength values may be directly viewed by a radiologist, or may be viewed overlaid with, or added to, or otherwise combined with a traditional reconstruction so that abnormal regions are brought to the attention of the radiologist. A CAD system may attempt to classify a large set of 3D locations, scanning over the entire 3D volume that is imaged (screening), or it may attempt to classify one or more particular points or regions that have been manually or automatically selected (diagnosis).

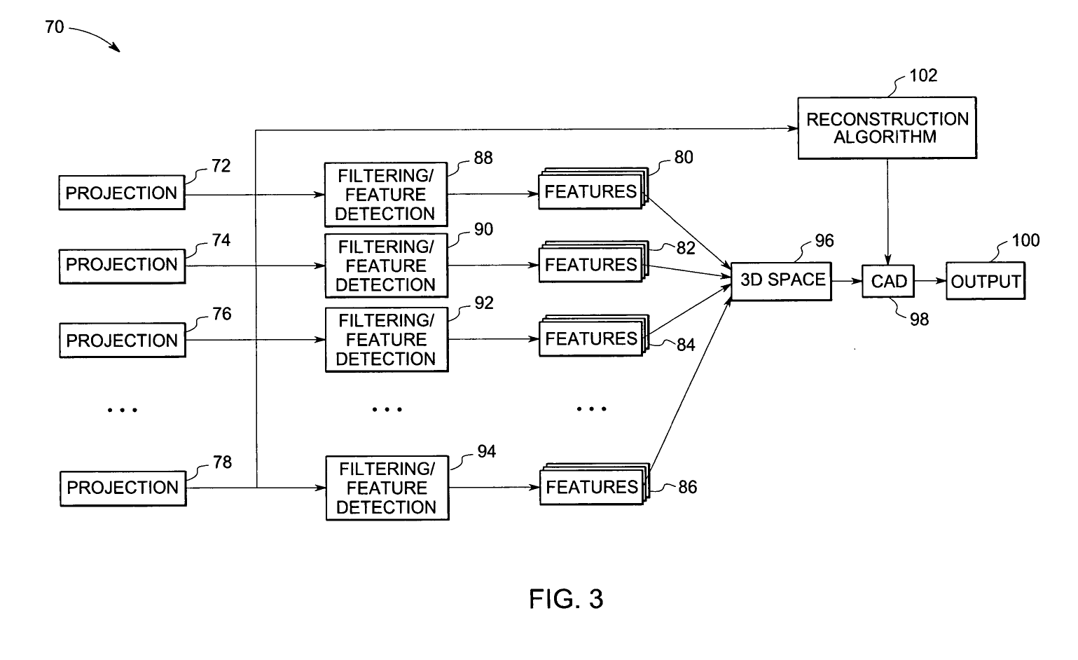

In contrast to the conventional CAD techniques described above, in embodiments of the present technique, 3D reconstruction is generally not used as a processing step prior to applying the CAD algorithm, i.e., the CAD process is not performed directly on the 3D reconstructed volume. In the techniques described in greater detail below the CAD system processes the 2D projection images to automatically detect and/or diagnose problems. For example, FIG. 3 illustrates an image analysis system or a CAD system 70 that is configured to operate on 2D projection images, in accordance with one embodiment of the present technique.

Referring now to FIG. 3, the CAD system 70 utilizes several projection images that are taken for some part of the anatomy with a variety of imaging system geometries. In other words, for the different images, the positions of the X-ray source and/or the X-ray detector, relative to the imaged anatomy, may be different. These projection image data are acquired from the tomosynthesis data source, and may also be data that was acquired previously, that is now being read from a PACS, or other storage or archival system. In accordance with a particular embodiment of the present technique, the projection images are accessed from the tomosynthesis system 10, as described in FIG. 1 and FIG. 2 (or from another imaging system, or a PACS system, etc). In certain embodiments, the projection images (or a subset thereof) may be generated from a 3D tomographic dataset via a reprojection operation as will be described in greater detail below. The 3D dataset may be acquired from an imaging system, or from a storage or archival system.

In an exemplary embodiment of the present technique, a set of projection images, indicated generally by the reference numeral 72, 74, 76 and 78, is initially selected for classifying one or more 3D test points (3D points of interest or classification points). It should be noted that the set may include one, all, or any number of the original projections images. The set of projection images may be selected from the original projection images based on X-ray dose used for the projection images or imaging geometry, so that the projection images that are potentially most useful are selected.

Further, a set of 3D test points is selected for classification. The set of 3D test points may be a set of samples over the whole 3D volume or a set of samples over a region of interest. This could be a regular or irregular sampling grid. It should be noted that the set of 3D test points may be hierarchical, that is, it may start with a coarse sampling and increase in resolution to a finer sampling wherever there is an indication of an anomaly in the coarser sampling. In one embodiment, the set of 3D test points may include only one test point. The set of 3D test points may be selected either manually or through some other automatic system, such as 2D CAD processing of the projection images or a subset of the projection images to generate a set of 2D test points for each projection image and then selecting 3D test points or regions by 3D reconstruction of the 2D test points. In order to manage non-consistent location and/or classification information from the selected 2D test points, this 3D reconstruction of test points may encompass elements as combination and classification of classifier outputs and features, as discussed in more detail below with reference to a subsequent processing step.

As will be appreciated by one skilled in the art, the state of the tissue at or near a particular 3D test point has some effect on the 2D projection images near the corresponding 2D projection coordinates. To determine the class of the tissue at a 3D location, the classification system uses features computed from the 2D projection images that are affected by the state of the tissue at the 3D location. Thus, in the present technique, for each 3D test point, the 2D projection point in each projection image in the set of projection images is determined using the imaging geometry. Further, for each projection image in the set, one or more of the features that distinguish the classes are computed from the projection image in the region nearby to (and including) the 2D projection point. These features are indicated generally by the reference numeral 80, 82, 84 and 86. They are computed via one or more feature detection techniques, indicated generally by the reference numeral 88, 90, 92 and 94, such as filtering, edge detection, etc. These features may be the projection image values themselves, or filtered versions of the projection images, or any type of image feature such as texture, shape, size, density, curvature and so forth. The features are generally assembled into a feature vector. As is known to those skilled in the art, each feature vector represents a parameter or a set of parameters that is designed or selected to help discriminate between a diseased tissue and a normal tissue. These feature vectors are designed or selected to respond to the structure of cancerous tissue, such as calcification, spiculation, mass margin and mass shape. Examples of components of a feature vector include pixel value measures, size and shape of an object or structure in the image, filter responses, wavelet filter responses, measures of the mass margin, or measures indicating the degree of spiculation. The feature vector may be a single value or may simply be the projection image pixel values. In certain embodiments, the feature vector may be the output of a set of linear and/or non-linear filters applied to the projection images 88, 90, 92 and 94. The feature vector may also include the output from classifiers acting on the projection images or on some appropriate combination of the computed features. These classifiers may include hard classifiers, and soft classifiers, including some measures of probability or confidence, etc. The feature vectors need not be computed on a grid in the projection images that corresponds to the projection image sampling grid, or the sample grid for the 3D region. The feature vectors may be computed on any grid and interpolated to the projection points where they are needed.

It should be noted that, in certain embodiments, the feature vectors may be computed in advance for each projection image, or for a region of each projection image. In other words, the feature values may be pre-computed for each projection image on a sampling grid that may correspond to the original sampling grid of the projection image. Thus, for each 2D projection image there is a corresponding pre-computed feature image. The feature values may then be extracted from the pre-computed feature images by interpolation such as nearest neighbor, bilinear, bicubic, spline interpolation methods and so forth. In this embodiment, the 3D test points are projected to 2D projection points and the respective projection points are then used to interpolate one or more feature values from the corresponding pre-computed feature image. Since a 2D location in a projection image is the projection point for many 3D locations, the features for a particular 2D location will be used in the classification of many 3D locations. Thus, there may be a computational savings if the features are computed for each 2D location in each projection image once, in advance. Alternatively, the feature values for the 2D projection images are not pre-computed on a 2D sampling grid, but are computed ‘on demand’ at or around the 2D projection points, as described above, once the 2D projection points are determined. In another embodiment, a combined approach may be used, where some of the features are pre-computed, and used for a first down-selection of points of interest while other features (the determination of which may be computationally more expensive) may be computed “on demand”.

The one or more detected features or feature vectors 80, 82, 84 and 86 are combined to form one or more representations of the 3D volumes of interest in 3D space 96. For example, corresponding elements of the feature vectors from different projection images may be combined into a corresponding 3D volume representative of the 3D distribution of that feature. These volumes of interest 96 may be reconstructed from the selected 2D projection points using a 3D reconstruction algorithm. In certain embodiments, combining the features detected from the 2D images may involve using a known reconstruction algorithm for tomosynthesis. For example, if some feature from the 2D images is simply averaged to obtain the corresponding value for the corresponding 3D location, then a simple backprojection reconstruction may be used to accomplish this combination of 2D features for the full 3D volume, or any desired volume of interest. The combination of the information extracted from the 2D images, as represented by the feature vectors, may also include shape reconstruction, leveraging for example edge and boundary features and differential attenuation as an indicator of thickness of the shape. This combination step may also include different reconstruction algorithms, applied to the projection images in order to create 3D volumes representative of the imaged anatomy. This step may also include a suitable combination of hard and soft classifiers, taking into account probabilities, confidence levels, etc.

Also, any combination of suitable classifications or measurements may be used (e.g., collected in a vector). In certain embodiments, one or more classifiers or measurements that indicate the probability of any given region to be “normal” (or “non-cancerous” or “benign”) may be applied. When combining the output of the 2D processing into a 3D result, a high probability (or high confidence) of “normal tissue” at any given location may be used to override any “suspicious” classifications found in one or more of the other 2D projection images.

The combined set of features, or a subset of it, from each of the projection images at the 2D projection points may then be provided to a classification system or a CAD algorithm 98 to classify the 3D information at the test point or the volume of interest and the outputs from those classifiers are combined to make a decision. The 3D information may comprise 3D volumes representative of different features, different 3D reconstructions, 3D information from different classifiers, as well as the elements of the feature vectors extracted from the 2D projection images at the corresponding 2D locations directly, without any prior combination step. The classification system 98 may be any suitable classification system, including a model-based Bayesian classifier, a maximum likelihood classifier, an artificial neural network, a rule based method, a boosting method, a decision tree, a support vector machine or a fuzzy logic technique. The classification system 98 may explicitly or implicitly generate an output parameter 100 showing the confidence in the decision made. This parameter may be probabilistic. For example, as will be appreciated by those skilled in the art, a Bayesian classifier produces likelihood ratios that reflect confidence in the decision made. On the other hand, classifiers, such as decision trees, that do not have an intrinsic confidence measure can be easily extended by assigning a confidence to each output, for example, based on the error rate on training data.

It should be noted that, instead of a classification system 98 (i.e., a “hard classifier” as described above), the output 100 may be a soft classification, i.e., some measurement, computed from the features, that is an indicator of the presence of a particular state of the tissue. For example, this indicator may be related to the presence of micro-calcifications, or round structures of any type. As will be appreciated by one skilled in the art, the measurements or classifications may be probabilistic in character. For example, there may be a confidence measure associated with each of the computed classifications or measurements. The confidence measures may be kept in a “confidence map” that gives the confidence for each corresponding entry in the classification map. The confidence measure may be an estimated probability. Confidence measures are useful in setting thresholds as to what is displayed to the radiologist, and in combining the output from multiple CAD algorithms. A probabilistic framework may be used and the likelihood of various models representing different abnormality and anatomical features may be weighed. The 3D point may then be classified according to the most likely model. Such information can be displayed to the radiologist as a digital contrast agent or findings based image enhancement, overlaid with the 2D projections or the 3D reconstruction.

It should be noted that more than one CAD algorithm and/or classifier may be employed for the feature extraction from the 2D projections as well as for the classification of the 3D information. For example, such operations may involve performing CAD operations individually on portions of the image data, and combining the results of all CAD operations (logically by “and”, “or” operations or both, “weighted averaging”, or “probabilistic reasoning”). In addition, CAD operations to detect multiple disease states or anatomical signatures of interest may be performed in series or in parallel.

As will be appreciated by one skilled in the art, the CAD algorithm of the present invention is extremely flexible as different numbers of features and/or classifiers, and different numbers of images or datasets at different stages of the process may be used. The process also lends itself to a successive refinement (or increasing confidence) of the classification by including more images and more information in successive stages of the process. For example, if the CAD system cannot make a decision with sufficient confidence, the complete process may then be repeated with additional projection images in the set of projection images or with synthetic projection images having higher resolution. Further, for 3D regions that may have been automatically determined to be “suspicious” previously, or that satisfy some other criterion, an additional 3D reconstruction 102 may be performed, followed by the CAD algorithm or the classification system 98 acting on the reconstructed 3D region of interest. This may provide additional information such as 3D shape or other information that may not be readily available from the projection images. Similarly, additional features may be computed that help increase the confidence in the decision. Also, for greater speed of computation, the initial selection of 3D points may be performed using a simple (and fast) filter, with added successive filters, features and/or classifiers (in 2D or in the 3D domain) for efficient and rapid down selection of suspicious regions.

As will be appreciated by one skilled in the art, in certain embodiments, the projection images may be divided into two or more sets based on the dose distribution. For example, high-dose images may be utilized as described above while low-dose images may be used in a second step to increase the detection confidence in those regions where the confidence is below a certain threshold, and to localize in 3D the findings. In other words, 2D CAD-like processing may be performed on one (or few) projection(s). If there are regions where the classification (detection) is not of sufficient confidence, the 3D approach may be used for the corresponding 3D region. For the regions corresponding to findings with high confidence, the corresponding 3D volume may be searched to locate the finding in 3D.

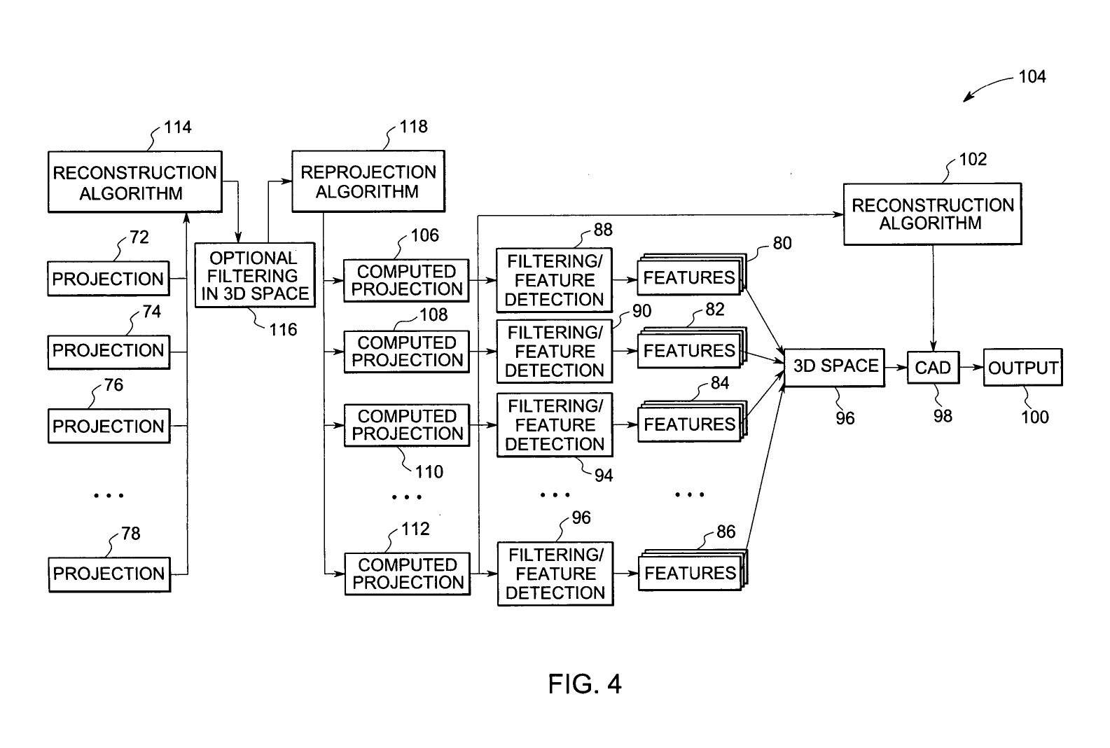

In certain embodiments, the set of projection images (or a subset thereof) may be produced via a reprojection operation. For example, FIG. 4 illustrates, an image analysis system or a CAD system 104 that is configured to operate on computed 2D projection images, indicated generally by the reference numeral 106, 109, 110 and 112, in accordance with aspects of the present technique. A reconstructed volume is generated via a 3D reconstruction 114 of the data from the projection images 72, 74, 76 and 78. The reconstructed volume maybe optionally filtered 116 to enhance contrast, reduce noise and so forth. Further, a new data set of projected images or synthetic projection images 106, 109, 110 and 112 may be generated from the reconstructed volume using a reprojection operation 118 by selecting one or more synthetic imaging geometries and resolution for the set of projection images. It should be noted that if the 3D test points can be determined beforehand, then the synthetic projection images need be computed only in regions surrounding the 2D projection coordinates of each 3D test point. As will be appreciated by one skilled in the art, since the 3D data set has been reconstructed from several projected views, the reprojected images computed from the 3D data set may have improved image quality (as measured by higher signal to noise ratio), which may improve the results of the overall process. It should be noted that a hierarchical reconstruction may be applied with this reconstruction-reprojection approach, that is, reprojection and further processing may be performed at different resolutions.

The output 100 of the CAD system may be evaluated images for review by human or machine observers. Thus, various types of evaluated images may be presented to the attending physician or to any other person needing such information, based upon any or all of the processing and modules performed by the CAD algorithm. The output 100 may include displaying images having two-or three-dimensional renderings, markers superimposed, color or intensity variations, and so forth. The findings from the reconstructions (as generated by the CAD algorithm) can be geometrically mapped to, and displayed superimposed on projection images, or a 3D reconstructed image generated specifically for 3D visualization, or other display. The findings can also be displayed superimposed on a subset or all of the generated reconstructed volumes. Location of findings can also be mapped to an image from another modality (if available), and the images acquired by other modality can be displayed, with the CAD results superimposed. The images acquired by the other modality may also be displayed simultaneously, either in a separate image, or superimposed in some way. The CAD results are stored for archival—maybe together with all or a subset of the generated data (projections and/or reconstructed 3D volumes). It should be noted that, in certain embodiments, the image data acquired by different modalities may also be processed by CAD algorithms to improved detection and/or diagnosis of anomalies. Combination of CAD results from other modalities with CAD results from 2D projections, as outlined herein above, may be performed in a similar fashion as the combination of CAD results from different 2D views, as discussed in more detail above. The combination of CAD results from multiple modalities may also include an optional registration step, which is used to align the geometries of the different datasets.

As will be appreciated by one skilled in the art, one of the features of the present technique is flexible and hierarchical use of any CAD-type processing in the various embodiments discussed above. For example, the present technique provides a flexible and hierarchical structure, allowing different degrees of complexity in processing to be configured for different situations. For instance, a simple filter may be applied for initial definition of regions of interest (classification points), more complicated filters may be applied for the 2D CAD portion, and even more complex filters may be applied for 3D CAD processing (classification). Further, the technique is flexible in terms of the number of datasets each CAD-type processing step is applied to. For example, some reasonably complex CAD filter may be applied on a single projection image while simple filters may be applied on more than one image mainly to reject false positives. The remaining region of interests may then be used for a more detailed analysis.

The embodiments illustrated above may comprise a listing of executable instructions for implementing logical functions. The listing can be embodied in any computer-readable medium for use by or in connection with a computer-based system that can retrieve, process and execute the instructions. Alternatively, some or all of the processing may be performed remotely by additional computing resources.

In the context of the present technique, the computer-readable medium may be any means that can contain, store, communicate, propagate, transmit or transport the instructions. The computer readable medium can be an electronic, a magnetic, an optical, an electromagnetic, or an infrared system, apparatus, or device. An illustrative, but non-exhaustive list of computer-readable mediums can include an electrical connection (electronic) having one or more wires, a portable computer diskette (magnetic), a random access memory (RAM) (magnetic), a read-only memory (ROM) (magnetic), an erasable programmable read-only memory (EPROM or Flash memory) (magnetic), an optical fiber (optical), and a portable compact disc read-only memory (CDROM) (optical). Note that the computer readable medium may comprise paper or another suitable medium upon which the instructions are printed. For instance, the instructions can be electronically captured via optical scanning of the paper or other medium, then compiled, interpreted or otherwise processed in a suitable manner if necessary, and then stored in a computer memory.

While only certain features of the invention have been illustrated and described herein, many modifications and changes will occur to those skilled in the art. It is, therefore, to be understood that the appended claims are intended to cover all such modifications and changes as fall within the true spirit of the invention.

1. A method for performing a computer aided detection (CAD) analysis of a three-dimensional volume, the method comprising:
selecting one or more three-dimensional points of interest in a three-dimensional volume;
forward projecting the one or more three-dimensional points of interest to determine a corresponding set of projection points within one or more two-dimensional projection images; and
computing output values at the one or more three-dimensional points of interest based on one or more feature values or a CAD output at the corresponding set of projection points.

2. The method of claim 1, wherein selecting the one or more points of interest is automatic or manual.

3. The method of claim 1, wherein selecting the one or more points of interest comprises selecting the one or more points of interest in accordance with a sampling pattern.

4. The method of claim 1, wherein selecting the one or more points of interest comprises performing a hierarchical selection of the one or more points of interest.

5. The method of claim 4, wherein performing the hierarchical selection comprises performing a first CAD-type processing on the one or more points of interest and performing a second CAD type processing on a subset of points, wherein the subset is selected from the one or more points of interest based on first CAD-type processing.

6. The method of claim 1, wherein selecting the one or more points of interest comprises deriving the one or more points of interest from the one or more two-dimensional projection images via a CAD algorithm.

7. The method of claim 1, further comprising pre-processing or processing the two-dimensional projection images at the corresponding set of projection points to generate the one or more feature values or the CAD output.

8. The method of claim 7, wherein pre-processing or processing the two-dimensional projection images comprises performing feature extraction, feature detection and/or CAD processing on the two-dimensional projection images.

9. The method of claim 8, wherein computing output values at the one or more three-dimensional points of interest comprises combining extracted features, detected features, or the CAD output at the corresponding set of projection points.

10. The method of claim 1, wherein computing output values at the one or more three-dimensional points of interest comprises reconstructing shapes based on segmentations from the two-dimensional projection images, region boundaries, and/or attenuation values.

11. The method of claim 1, wherein computing output values at the one or more three-dimensional points of interest comprises classifying the three-dimensional volume based on the one or more feature values or the CAD output.

12. The method of claim 11, wherein computing output values at the one or more three-dimensional points of interest comprises processing the three-dimensional data acquired from different modality by computing one or more feature values or a CAD output.

13. The method of claim 1, wherein computing output values at the one or more three-dimensional points of interest comprises analyzing the one or more feature values or the CAD output using one of more automated routines or performing CAD on the one or more feature values or the CAD output.

14. A method for performing a computer aided detection (CAD) analysis of a three-dimensional volume, the method comprising:
acquiring a plurality of projection images of a three-dimensional volume;
selecting one or more projection images from the plurality of acquired projection images;
selecting one or more classification points within the three-dimensional volume;
determining a projection point for each classification point within each of one or more projection images based on a respective imaging geometry of each of the one or more projection images; and
classifying each classification point using one or more feature values for the respective projection points associated with each classification point.

15. The method of claim 14, further comprising precomputing the one or more feature values or a feature image for each of the one or more projection images, wherein the feature image for each of the one or more projection images is a set of feature values for the respective projection image.

16. The method of claim 14, further comprising computing one or more feature values within each of the one or more projection images, wherein each feature value is calculated using a region of the respective projection image proximate to a respective projection point within the respective projection image.

17. The method of claim 14, wherein selecting the one or more projection images comprises selecting the one or more projection images from the plurality of acquired projection images based on a respective X-ray dose and/or the respective imaging geometry associated with each of the one or more projection images.

18. The method of claim 14, comprising reprojecting the one or more projection images from the three-dimensional volume using a respective synthetic imaging geometry to reproject each projection image.

19. The method of claim 14, wherein selecting the one or more classification points comprises selecting the one or more classification points within one or more regions of interest within the three-dimensional volume.

20. The method of claim 14, wherein selecting the one or more classification points comprises selecting the one or more classification points in accordance with a sampling pattern.

21. The method of claim 14, wherein selecting the one or more classification points comprises performing a hierarchical selection of the one or more classification points.

22. The method of claim 14, wherein selecting the one or more classification points comprises:
applying one or more routines to some or all of the plurality of projection images to select one or more preliminary points within the plurality of projection images; and
reconstructing the one or more preliminary points to generate the one or more classification points.

23. The method of claim 14, wherein each feature value comprises a vector and/or one or more pixel values of the respective region.

24. The method of claim 14, wherein computing the one or more feature values comprises applying a set of linear and/or non-linear filters to the one or more projection images.

25. The method of claim 14, wherein classifying each classification point comprises combining the respective feature values for the respective projection points associated with each classification point.

26. The method of claim 14, wherein classifying each classification point comprises providing a hard and/or soft classification to a user or a downstream routine.

27. The method of claim 14, wherein classifying each classification point comprises providing a measure related to the presence of an anatomical feature or abnormality to a user or a downstream routine.

28. The method of claim 27, wherein the measure related to the presence of the anatomical feature or abnormality is computed at each sample point and is overlayed or combined with a reconstruction for viewing.

29. The method of claim 14, wherein classifying each classification point comprises using a probabilistic framework to assess a likelihood for each of two or more classification models and classifying each classification point based on the likelihood.

30. The method of claim 14, wherein classifying each classification point comprises providing the respective feature values for the respective projection points associated with each classification point to a Bayesian classifier, a maximum likelihood classifier, a rule based method, a decision tree, a support vector machine, a boosting method, fuzzy logic technique, or an artificial neural network, each configured to output a classification.

31. The method of claim 14, comprising reconstructing a three-dimensional volume of interest using some or all of the plurality of projection images based on the classification of some or all of the one or more classification points.

32. The method of claim 31, comprising analyzing the three-dimensional volume of interest using one of more automated routines.

33. An image analysis system, comprising:
a processor configured to select one or more three-dimensional points of interest in a three-dimensional volume, to forward project the one or more three-dimensional points of interest to determine a corresponding set of projection points within one or more two-dimensional projection images, and to compute output values at the one or more three-dimensional points of interest based on one or more feature values or a CAD output at the corresponding set of projection points.

34. The image analysis system of claim 33, comprising:
a source of radiation for producing X-ray beams directed through an imaging volume; and
a detector adapted to detect the X-ray beams and to generate signals representative of the plurality of projection images.

35. A computer readable media, comprising:
routines for selecting one or more three-dimensional points of interest in a three-dimensional volume;
routines for forward projecting the one or more three-dimensional points of interest to determine a corresponding set of projection points within one or more two-dimensional projection images; and
routines for computing output values at the one or more three-dimensional points of interest based on one or more feature values or a CAD output at the corresponding set of projection points.
